(19) United States
(12) Patent Application Publication
(10) Pub. No.: US 2026/0037930 A1
(43) Pub. Date: Feb. 5, 2026

(54) METHOD AND AN ASSEMBLY FOR MONITORING A VEHICLE

(71) Applicant: Ford Global Technologies, LLC, Dearborn, MI (US)

(72) Inventors: Marcel Grein, Geilenkirchen (DE); Turgay Isik Aslandere, Aachen (DE)

(73) Assignee: Ford Global Technologies, LLC, Dearborn, MI (US)

(21) Appl. No.: 19/278,544

(22) Filed: Jul. 23, 2025

(30) Foreign Application Priority Data
Jul. 31, 2024 (DE) 102024121834.7

(51) Int. Cl. G06Q 10/20; G06T 7/00; G07C 5/00; G07C 5/08

(52) U.S. Cl. CPC G06Q 10/20; G06T 7/0004; G07C 5/008; G07C 5/0816; G06T 2207/20084; G06T 2207/30252

(57) ABSTRACT

The disclosure generally relates to a method and an assembly for monitoring a vehicle. At least image data relating to a vehicle in a workshop that is inaccessible to the vehicle user are captured by at least several cameras. At least the captured image data are evaluated by a control device based on at least one algorithm that includes generative artificial intelligence. At least the evaluated image data are output by at least one output device.

### CROSS-REFERENCE TO RELATED APPLICATIONS

The present application claims priority to and the benefit of German Application No. 102024121834.7, filed Jul. 31, 2024, which is hereby incorporated by reference herein in its entirety.

### FIELD

The disclosure generally relates to a method and an assembly for monitoring a vehicle.

### BACKGROUND

Vehicles are often located in environments that are inaccessible to the vehicle user. For example, the vehicle user typically does not have access to a workshop when maintenance or repair measures are carried out on their vehicle. The vehicle user then has no opportunity to view their vehicle and/or the work processes during a maintenance or repair measure. On the other hand, there is a general need for transparency on the part of vehicle users today, who have an interest in knowing, for example, whether their vehicle is being handled with care. In addition, the vehicle user typically also wants to know which maintenance or repair measures are carried out on their vehicle and in what way.

Previous approaches, such as those known from U.S. Pat. No. 11,411,960 B2, U.S. Pat. No. 11,358,613 B2, US 2019/0272508 A1 and US 2023/0377047 A1, reveal systems in which vehicles can be captured by cameras in order to provide the vehicle user with image data relating to the vehicle. However, the image data are not evaluated with regard to the actual visible objects. In other words, the camera perspective may not be suitable for perceiving the vehicle in accordance with the activities being performed.

There is therefore a need to eliminate or at least reduce the disadvantages of known methods and assemblies for monitoring a vehicle. In particular, there is a need to be able to recognize specific activities based on the output image data.

### SUMMARY

The object is achieved by the subject-matter of the independent claims. Advantageous embodiments are given in the dependent claims and the description below, each of which can represent aspects of the disclosure separately or in (sub)combination. Some features are explained in terms of the method, others in terms of assemblies. However, the corresponding aspects are reciprocally transferred in corresponding ways.

According to one aspect, some embodiments of the disclosure relate to a method for monitoring a vehicle. The method includes at least the following steps:
at least image data relating to a vehicle are captured by at least several cameras in a workshop that is inaccessible to the vehicle user.
at least the captured image data are evaluated by a control device based on at least one algorithm that includes generative artificial intelligence. The algorithm selects, at least temporarily, those image data that correspond to a specific camera perspective of one of the several cameras, based on which a maintenance or repair measure carried out on the vehicle can be optimally recognized.
at least the evaluated image data are output by at least one output device.

The method is based on the knowledge that a specific algorithm that has a corresponding generative artificial intelligence can be used to evaluate which camera perspective allows a specific maintenance or repair measure to be detected in an optimal way. As a result, the output of the image data are adapted in such a way that the respective maintenance or repair measure can actually be perceived by a vehicle user. For example, it prevents a video stream from being output that does not allow a specific maintenance or repair measure to be perceived, for example because it takes place in the area of the underbody of the vehicle, while the camera perspective shows the vehicle from above. According to the method, the image data are always selected that correspond to a camera perspective for the vehicle user, according to which the corresponding maintenance or repair measure can be optimally perceived. As a result, the vehicle user is able to monitor their vehicle even though it is positioned in an area that is not accessible to them. In addition, they can also find out about the service process and better understand what they may be paying for. The service process is therefore becoming more transparent. They can also learn more about their vehicle and use the image data output, for example, to find out how they can use their vehicle in a more maintenance-friendly way, for example to prevent costly component replacement. It also creates a way to entertain the vehicle user.

According to another aspect, some embodiments of the disclosure relate to an assembly for monitoring a vehicle. The assembly has at least several cameras, a server data memory coupled to the cameras, a control device coupled to the server data memory and at least one output device coupled to the control device. The cameras are arranged in a workshop that is inaccessible to the vehicle user and are set up to at least capture image data relating to a vehicle in the workshop and to transmit the recorded image data to the server data memory. The control device is at least set up to evaluate at least the captured image data based on at least one algorithm that includes generative artificial intelligence and to output the evaluated image data using at least one output device. The algorithm selects, at least temporarily, those image data that correspond to a specific camera perspective of one of the several cameras, based on which a maintenance or repair measure carried out on the vehicle can be optimally recognized.

The advantages achieved by the method described herein are also achieved in a corresponding manner by the assembly.

In the present case, the workshop that is inaccessible to the vehicle user can be understood to mean that it is an area for which the vehicle user's access is not automatically permitted during the normal operation of the workshop, at least not without the consent or permission of the workshop operator or an employee. Typically, access for vehicle users is not readily allowed, for example to prevent unwanted interactions during the operation of the workshop.

In the present case, at least temporarily can be understood to mean that the optimal camera perspective is guaranteed for a non-negligible period of time.

Preferably, the control device can also evaluate the captured image data in such a way that the image data that correspond to a camera perspective of one of the several cameras, according to which a respective maintenance or repair measure can be optimally recognized, is permanently selected.

Preferably, the cameras can be internal or external to the vehicle. For example, the environment cameras that are already available on the vehicle can be used to capture corresponding image data.

An alternative can also be cameras that are arranged in the workshop area and oriented in such a way that specific maintenance or repair measures can be captured by them.

Another alternative can also be cameras that are worn on the body (bodycam) by a fitter or workshop employee who is carrying out a corresponding maintenance or repair measure. For example, the workshop employee can wear the camera in the chest area or as a forehead camera.

When evaluating the captured image data, the control device evaluates the image data with regard to the maintenance or repair measure to be carried out or that is being carried out. Thus, those image data are determined that correspond to a specific perspective and that provide an optimal view of the maintenance or repair measure.

During the output, exactly the image data are output that allow the optimal view (perspective) of the respective maintenance or repair measure.

Preferably, the control device also evaluates the captured image data with regard to a maintenance protocol to be carried out with regard to the vehicle. When the image data are output, progress information is also output, which shows the progress relative to the maintenance protocol. As a result, the vehicle user is informed of how far the maintenance and repair measures have progressed. As a result, the vehicle user is able to better estimate when the maintenance protocol will end and the vehicle will be available again.

Alternatively, the progress information can also include additional information about the individual work steps of the maintenance or repair measures.

When it comes to information about progress, it can also be taken advantage of that for many maintenance or repair measures, the sequences of the corresponding measures are clearly defined. In this way, the control device can use the algorithm to reliably evaluate which work step is currently being processed.

The progress information can be taken into account in the output, for example, in the form of a progress bar or a progress percentage display.

Optionally, the control device adapts the captured image data in such a way that people's faces and/or personal information are unrecognizable. This can prevent personal information from being disclosed in the course of the method. This can also increase employee acceptance of the method.

In some embodiments, the control device also outputs at least one additional piece of information when outputting the image data. In this way, the information content for the vehicle user can be increased even more.

Preferably, the additional information is relevant with regard to the maintenance or repair measures carried out. For example, the additional information can be used to communicate which components are installed in the vehicle or used for maintenance purposes. As a result, the additional information is specifically adapted to the maintenance or repair measures carried out, so that the relevance for the vehicle user is even higher.

Preferably, the captured image data are processed by the control device in a server data memory. This means that the cameras transmit the captured image data to the server data memory. This means that there is no need to maintain a complex computing infrastructure in the workshop area. Rather, the control device can process the data directly on the server data memory. Thus, even for methods relating to different vehicles, only a single control device needs to be taken into account.

Optionally, the algorithm of the control device has at least one algorithm for object tracking. In particular, the algorithm of the control device may have a YOLO V4 algorithm. This allows specific components of the vehicle to be tracked, such as the vehicle wheels. Using the object tracking, the image data on the basis of which the vehicle can be optimally perceived can be automatically selected. In addition, object tracking can also be used with regard to components for which maintenance or repair measures are carried out, such as vehicle wheels, oil tanks or the like.

Diagnostic data are preferably read out from the vehicle by means of at least one diagnostic device that is coupled to a data bus, preferably a CAN bus, of the vehicle. The read-out diagnostic data are also taken into account in the evaluation of the captured image data by a control device. For example, the diagnostic data can be used to determine which component of the vehicle is being serviced or repaired. This information can be used during the evaluation of the image data.

In some embodiments, the algorithm of the control device has at least a large language model. The data processed in the large language model are converted into token sequences and processed. This enables computationally efficient processing of the data.

Preferably, the large language model includes different transformer architectures (also called transformers) for fine-tuning to different tasks, such as the identification of different objects or work steps in the context of the maintenance and repair measures.

The large language model is preferably pre-trained and includes a SoftMax layer in a known way.

Optionally, audio data relating to the vehicle in the workshop which is inaccessible to the vehicle user are also captured by at least one microphone and taken into account by the control device during the evaluation. This allows the evaluation to be placed on a broader information basis, which increases the precision and reliability of the evaluation. For example, a fitter or workshop employee can also make voice inputs to indicate which maintenance or repair measure they are performing. This information can then be taken into account as part of the evaluation and ensure an optimal result for the vehicle user.

Preferably, the evaluated audio data are also output by the output device. This creates an additional information channel for the vehicle user.

Preferably, the output device is wirelessly coupled to the control device. This means that the data can also be output to devices remote from the control device, in particular mobile devices. Wireless pairing can be done, for example, using Bluetooth, Wi-Fi, or a mobile communications standard, such as 4G, 5G or 6G.

In some embodiments, the output device contains at least one of the following: a screen, in particular a television or computer screen, and a mobile device, such as a smartphone, tablet, laptop or similar. For example, the TV may be positioned in a customer room (waiting room) associated with the workshop. This means that the vehicle user can be informed immediately about the status of the maintenance or repair measures without the need for direct contact with employees.

The output image data can also be made available via a web interface that the vehicle user calls up on a corresponding Internet-enabled device.

In some embodiments, the method takes place in real time, except for the time required to capture and evaluate the image data and to output the evaluated image data. In this way, time losses can be avoided, and the vehicle user receives the information immediately.

Optionally, the method is designed as a computer-implemented method. This means that the steps of the method can be carried out with the help of one or more data processing devices. In particular, a data processing device of the control device can trigger or perform the corresponding steps.

According to a further aspect, the disclosure also relates to a computer program product, comprising commands which, when executed by a computer, cause the computer to carry out the method as described herein. The advantages achieved by the method described herein are also achieved in a corresponding manner by the computer program product.

According to an additional aspect, the disclosure also relates to a computer-readable memory medium, containing commands which, when executed by a computer, cause the computer to carry out the method as described herein. The advantages achieved by the method described herein are also achieved in a corresponding way by the computer-readable memory medium.

For the purposes of disclosure, vehicles may include, in particular, land vehicles, namely, inter alia, off-road and on-road vehicles such as passenger cars, buses, lorries and other commercial vehicles. Vehicles can be manned or unmanned. Vehicles can be at least partially electrically driven, have an internal combustion engine and/or an electric motor serving as a propulsion system.

All the features explained with regard to the various aspects can be combined individually or in (sub-)combination with other aspects.

### BRIEF DESCRIPTION OF THE DRAWINGS

The disclosure as well as other advantageous embodiments and developments of the same are described and explained in more detail below using the examples shown in the drawings. In the figures:

FIG. 1 shows a simplified schematic representation of an assembly for monitoring a vehicle according to an embodiment.

FIG. 2 shows a simplified schematic representation of some components of the assembly for monitoring a vehicle according to an embodiment.

FIG. 3 shows a simplified schematic representation of a method of monitoring a vehicle according to an embodiment.

FIG. 4 shows a simplified schematic representation of the functioning of the assembly according to an embodiment.

FIG. 5 shows a simplified schematic representation of an architecture of the large language model used in the method.

FIG. 6 shows a simplified schematic representation of an architecture of the transformer of the large language model used in the method, and

FIG. 7 shows a simplified schematic representation of an exemplary output of the image data using an output device in the context of the method.

### DETAILED DESCRIPTION

The detailed description below, in conjunction with the accompanying drawings, in which the same numbers refer to the same elements, is intended as a description of different embodiments of the disclosed object and is not intended to represent the single embodiments. Each embodiment described in this disclosure is intended only as an example or illustration and should not be construed as favored or advantageous over other embodiments. The illustrative examples contained herein do not claim to be exhaustive and do not limit the claimed subject matter to the exact disclosed forms. Various variations of the embodiments described are readily recognizable to the person skilled in the art and the general principles defined herein can be applied to other embodiments and applications without departing from the spirit and scope of the embodiments described. Therefore, the embodiments described are not limited to the embodiments shown, but have the widest possible scope of application that is compatible with the principles and features disclosed here.

All the features disclosed below in relation to the exemplary embodiments and/or the accompanying figures may be combined, alone or in any sub-combination, with features of the aspects of the disclosure, including features of preferred embodiments, provided that the resulting combination of features is reasonable to a person skilled in the field of technology.

For the purposes of the disclosure, the phrase “at least one of A, B and C” means, for example, (A), (B), (C), (A and B), (A and C), (B and C) or (A, B and C), including all other possible combinations if more than three elements are listed. In other words, the term “at least one of A and B” generally means “A and/or B”, namely “A” alone, “B” alone or “A and B”.

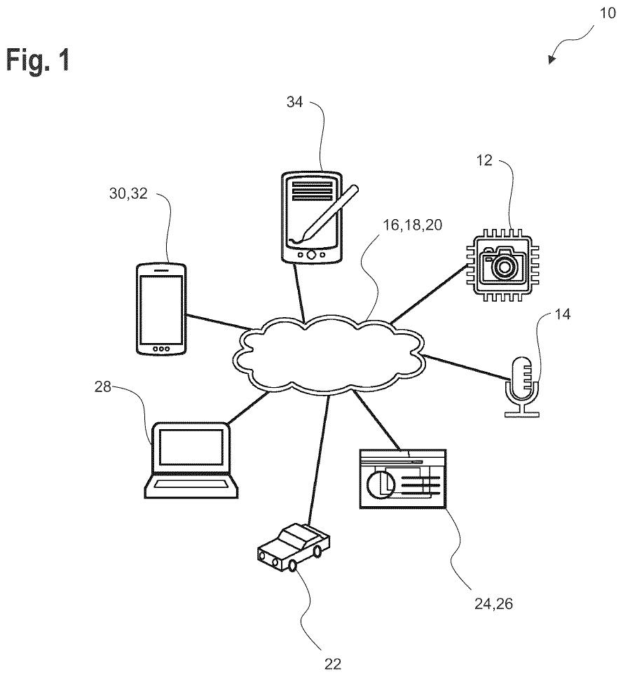

FIG. 1 shows a simplified schematic representation of an assembly 10 for monitoring a vehicle according to an embodiment.

According to this embodiment, the assembly 10 contains several cameras 12, and at least one, generally optional microphone 14. The cameras 12 and the microphone 14 are coupled to a server data memory 16 (cloud storage) and are set up to transmit captured image data or captured audio data to the server data memory 16.

The server data memory 16 contains or is coupled to at least one control device 18, which contains an algorithm 20 for evaluating the received data.

According to this embodiment, the assembly 10 also contains a data bus 22, in particular a CAN data bus, of the vehicle, which is also coupled to the server data memory 16. Using the data bus 22, diagnostic data can be read out of the vehicle and transmitted to the server data memory 16. In this case, the control device 18 may act as a diagnostic device for the determination of the diagnostic data, or the control device 18 may access an internal diagnostic device of the vehicle or an external diagnostic device which determines the diagnostic data and transmits it to the control device 18.

The control device 18 is set up using the algorithm 20 to evaluate received data, including image data, audio data, and diagnostic data, within the server data memory 16. In addition, the control device 18 is set up to transmit the corresponding evaluated data to an output device 24.

Optionally, the algorithm 20 has a pre-trained large language model for evaluating the captured image data. The data processed in the large language model are converted into token sequences and processed in this way.

The assembly 10 contains at least one output device 24 which is set up to output the data evaluated by the control device 18 for a vehicle user. According to this embodiment, the output device 24 may be designed in different ways. For example, the output device 24 can be in the form of a web interface 26 that can be called up via the Internet. Alternatively, the output device 24 can be a laptop 28 or a computer with a screen and/or a loudspeaker that is used to output the evaluated data. In another alternative, the output device 24 can also be a mobile device 30, such as a smartphone 32 or a tablet 34.

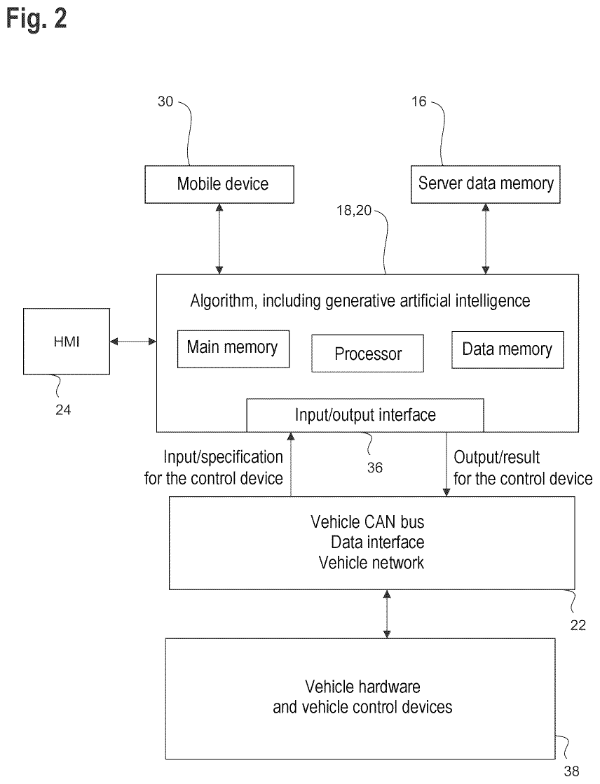

FIG. 2 shows a simplified schematic representation of some components of the assembly 10 for monitoring a vehicle according to an embodiment.

The control device 18 contains the algorithm 20 and is coupled to the server data memory 16. In addition, the control device 18 contains a main memory for processing the data, at least one processor (data processing device) and an internal data memory. In addition, the control device 18 contains an input/output interface 36.

Using the input/output interface 36, the control device 18 can communicate with a vehicle control device 38 via the data bus 22 of the vehicle, for example to read out diagnostic data of the vehicle via the data bus 22.

In addition, the control device 18 is coupled to an output device 24, for example in the form of mobile devices 30, in the manner already explained. In particular, the coupling between the control device 18 and the output device 24 can be wireless, for example by means of Bluetooth, Wi-Fi, or a mobile communications standard, such as 4G, 5G or 6G.

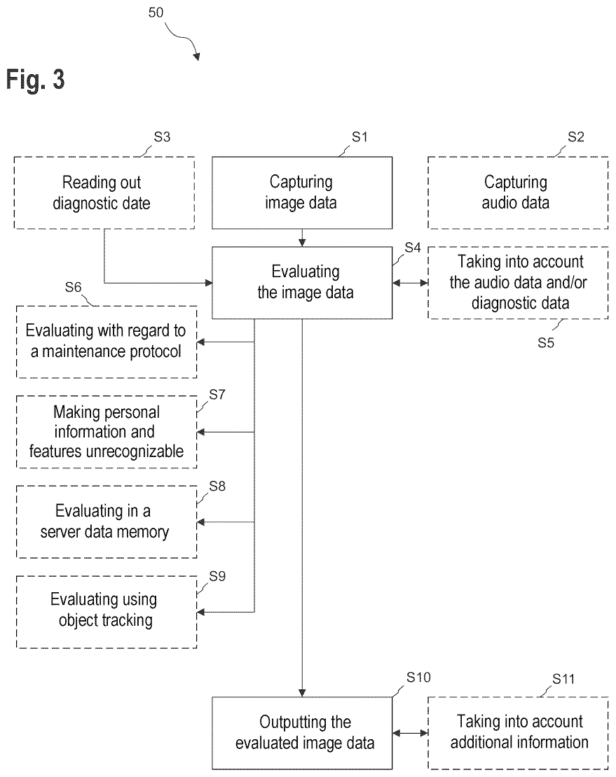

FIG. 3 shows a simplified schematic representation of a method 50 for monitoring a vehicle according to an embodiment. Optional steps are shown in dashed form. In general, the method 50 is set up to make it possible to monitor and trace a maintenance or repair measure carried out on the vehicle in a workshop that is inaccessible to the vehicle user on the basis of output playback data.

The method 50 includes the step S1, in which at least image data relating to a vehicle in a workshop that is inaccessible to the vehicle user are captured by at least several cameras 12.

Optionally, the method 50 may also include the step S2, in which audio data relating to the vehicle in the workshop inaccessible to the vehicle user are also captured by at least one microphone 14.

In addition, the method 50 can be developed in such a way that diagnostic data are read out from the vehicle in accordance with the optional step S3 by means of at least one diagnostic device that is coupled to a data bus 22 of the vehicle. For example, the diagnostic device can be internal to the vehicle or can be formed by the control device 18.

The method 50 then has the subsequent step S4, in which at least the captured image data from step S1 are evaluated by a control device 18 based on at least one algorithm 20. The algorithm includes a generative artificial intelligence. During the evaluation, in step S4 the algorithm 20 at least temporarily selects those image data that correspond to a specific camera perspective of one of the several cameras 12, on the basis of which a maintenance or repair measure carried out on the vehicle can be optimally recognized.

Step S4 can be developed in a variety of ways. For example, in accordance with the optional step S5, during the evaluation of the captured image data the control device 18 can also take into account captured audio data and/or read-out diagnostic data. This can make it possible, for example, to determine which maintenance or repair measures are being carried out on the vehicle, or a fitter or workshop employee can provide explanations that can be taken into account.

Optionally, the method 50 can also include step S6, in which the captured image data are additionally evaluated by control device 18 with regard to a maintenance protocol to be carried out with regard to the vehicle. For example, the control device 18 can determine which maintenance or repair measures are to be carried out on the vehicle on the basis of the maintenance protocol. The captured image data can then be compared with the maintenance or repair actions of the maintenance protocol by the control device 18 to determine which maintenance or repair action is currently being performed. As a result, the control device 18 can determine the progress relative to the maintenance protocol.

In addition, step S4 can also be developed by the optional step S7, in which the control device 18 adjusts the captured image data (and any other captured audio and/or readout diagnostic data) in such a way that people's faces and/or personal information are made unrecognizable. This can prevent personal information from being revealed.

In general, step S4 can also be developed by the optional step S8, in which the control device 18 evaluates the captured image data (and any other captured audio data and/or read diagnostic data) within the server data memory 16.

In addition, according to the optional step S9, when the captured image data are evaluated by the algorithm 20 of the control device 18, an object tracking function with regard to a component of the vehicle can be generated. For this purpose, the algorithm 20 can include an algorithm for object tracking, such as a YOLO V4 algorithm.

The method 50 then comprises the step S10, in which the evaluated image data are output by at least one output device 24, for example by a mobile device 30.

If the method 50 includes the optional step S5, the evaluated audio data and/or the read out diagnostic data can optionally also be taken into account during the output. In this way, combined data can be output for the vehicle user.

Optionally, the method 50 can also include step S11, in which additional information is taken into account by the control device 18 when the evaluated image data are output. This means, for example, that additional information can be output in addition to the pure image data, such as information about consumables used or replacement components. In this way, the vehicle user can find out which resources are used in the course of the activities.

If the method 50 includes the optional step S6, then the control device 18 also takes into account progress information which indicates the progress against the maintenance protocol during the output of the evaluated image data. For example, the progress information may include a progress bar that is taken into account during the output and that indicates the part of the maintenance and repair actions in the maintenance protocol that has already been completed.

The method 50 preferably runs in real time, except for the time required for the acquisition and evaluation of the image data and the output of the evaluated image data. The vehicle user is thus immediately informed about the progress of the method 50.

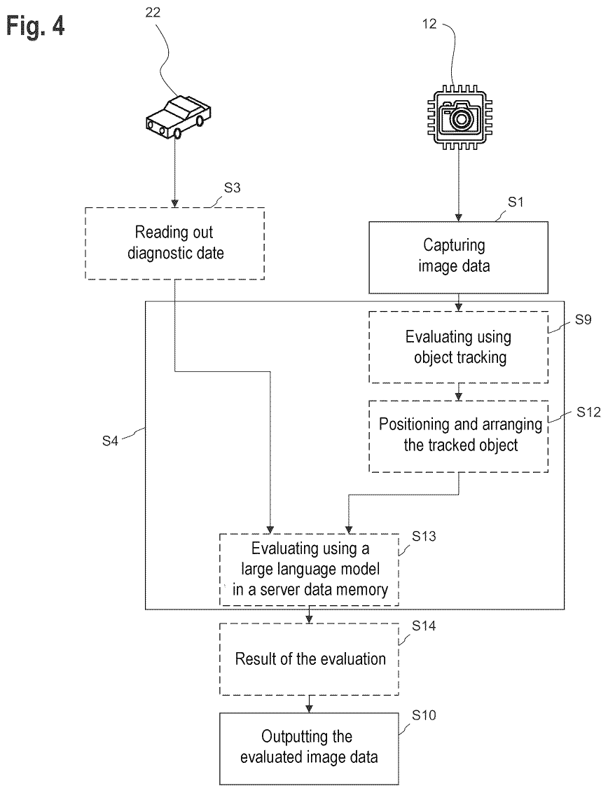

FIG. 4 shows a simplified schematic representation of the exemplary operation of the assembly 10 according to an embodiment. Here, too, optional steps are shown in dashed form.

The mode of operation of the assembly 10 shown in FIG. 4 is only exemplary and may also have a different form in other embodiments of the method 50.

According to this embodiment, in step S1 several cameras 12 are used to capture image data of the vehicle in the workshop which is inaccessible to the vehicle user.

In the subsequent step S4, the captured image data are evaluated by the control device 18. According to this embodiment, an object tracking algorithm is used for this purpose, according to the optional step S9.

As a result, in the optional step S12, the position and arrangement of predefined components of the vehicle are determined as a result of the optional step S9 and are tracked in the captured image data.

At the same time, diagnostic data are read out from a data bus 22 of the vehicle in accordance with the optional step S3 and, according to this embodiment, are taken into account during the evaluation in step S4.

Subsequently, the optional step S13 is used to evaluate the captured image data in the server data memory 16 by the control device 18 using a large language model.

Through the tracking and this type of evaluation, the control device 18 can determine which image data are suitable to ensure optimal visibility for the vehicle user to perceive the appropriate maintenance or repair measures. This means that the camera perspective which enables an optimal view of the maintenance or repair measures can be selected on the basis of object tracking by the control device 18. In accordance with this embodiment, the control device 18 takes into account the diagnostic data that are read out.

In the optional step S14, the result of the evaluation is provided by the control device 18.

The evaluated image data are then output by an output device 24 according to step S10. Artificial intelligence is used to select the optimal camera perspective for the vehicle user, which allows them to perceive the maintenance or repair measures carried out in the best possible way.

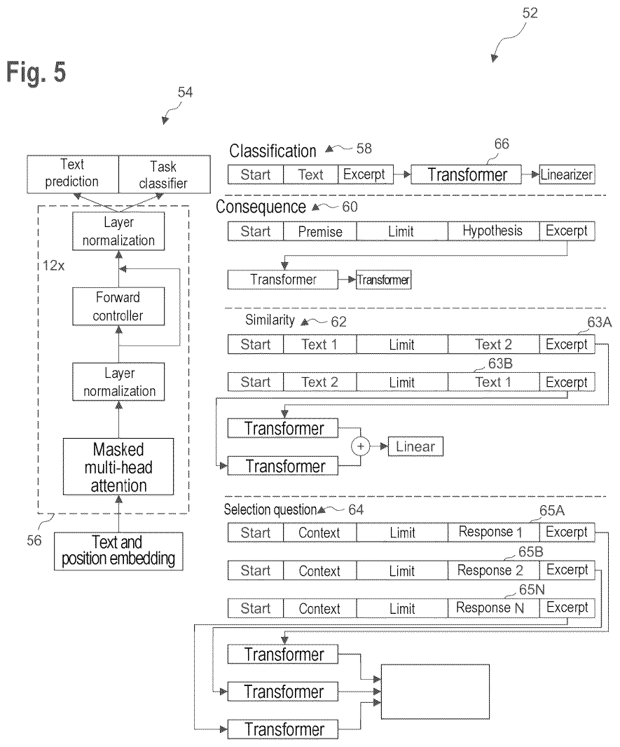

FIG. 5 shows a simplified schematic representation of an architecture of the pre-trained large language model 52, which is used in the method 50. The large language model 52 is well known.

54 denotes the high-level structure of the Large Language Model 52. Based on a text and position embedding, the corresponding input data are provided for twelve parallel work blocks 56. The work blocks 56 have a unit for masked multi-head attention on the input side, which is followed by a layer standardization and a forward controller. Starting with another unit for layer standardization, the result of work block 56 is used as part of a unit for text prediction and/or a task classifier.

The classifier is denoted by 58, in which an excerpt is selected from the corresponding text starting from a starting unit, which is fed to a transformer 66, which is followed by a linearization.

60 denotes the consequence unit in which a premise is established starting from the starting unit, which is then limited. As a result, a hypothesis is obtained from which an excerpt is extracted, which in turn is fed to the transformer 66, which is also followed by a linearization.

62 denotes a similarity unit in which two parallel data processes are carried out. Starting from a starting unit, a first text part “Text1” is fed to a limiting unit in a first strand 63A. This results in a second text part “Text2”, from which an excerpt is extracted, which is then fed to the transformer 66. At the same time, starting from a starting unit in a second strand 63B, the second text part “Text2” is fed to a limiting unit. This (optimally) results in the first part of the text “Text1”, from which an excerpt is extracted, which is then fed to the transformer 66. Starting from the two transformers 66, the corresponding results are summed up and fed to the linearization unit.

In addition, a selection question 64 (multiple choice) unit is used. The selection question unit 64 generally includes n (n is a natural number) parallel strands 65A to 65N. For each strand 65, starting from a starting unit, a context unit is used and subjected to a limit, resulting in an nth response corresponding to the nth strand 65N. The nth response is fed to an extraction unit, which is used to extract a part, which is then fed to a transformer 66. The results of the respective transformers 66 are then merged.

As can be seen from FIG. 5 using the units for classification 58, consequence 60, similarity 62 and selection question 64, the processed data are converted into token sequences within the pre-trained Large Language Model 52 and processed in this way.

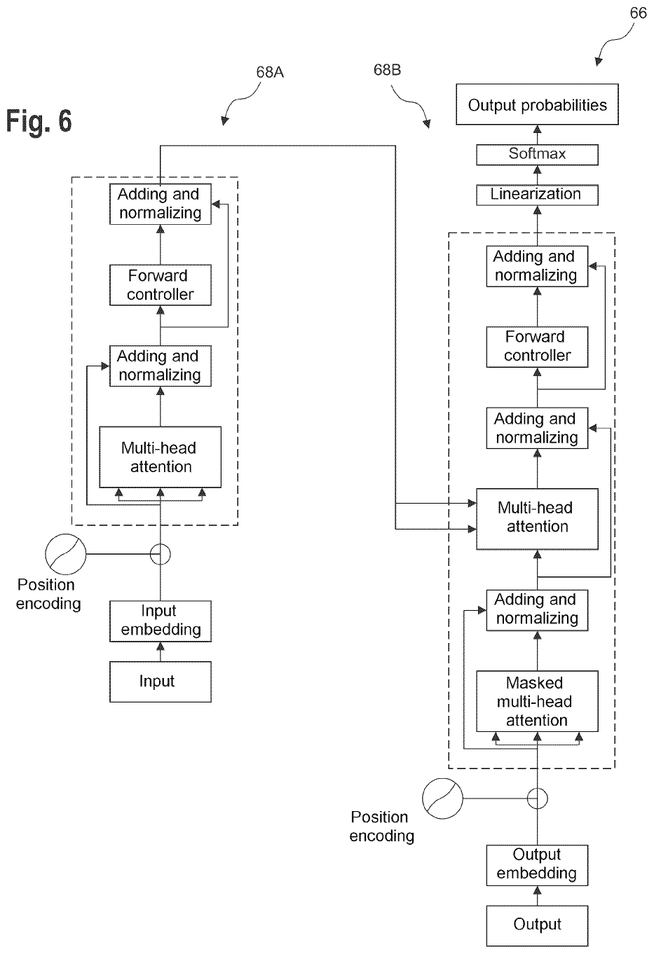

FIG. 6 shows a simplified schematic representation of an architecture of the transformer 66 of the Large Language Model 52, which is used in the context of the method 50.

The transformer 66 has a first part 68A. Within the first part 68A, the data are fed from the input of a unit to the input embedding. The position coding of the data are then taken into account. The position-coded data are then fed to multi-head attention and then added and normalized. The data treated in this way are fed to a forward regulator and added and normalized again, wherein the result of the first part 68A of the transformer is determined.

The transformer 66 also has a second part 68B, in which the output is taken into account. The output is offset with respect to the input. Starting with the output, the data are fed to a unit for output embedding. The position coding of the data are then taken into account. The position-coded data are then fed to a masked multi-head attention and then added and normalized. The data treated in this way are now fed to another unit for multi-head attention, to which the output data (result) of the first part 68A of the transformer 66 are also supplied. After a subsequent unit for addition and normalization, the data are fed to another forward controller, which is followed by another unit for addition and normalization. The data treated in this way are then linearized and then fed to a Softmax layer of the transformer 66. As the result of the second part 68B, the transformer 66 gives output probabilities for the different data from different outputs based on the data of a specific input. The output probabilities thus indicate how likely it is that data from a specific input of the transformer 66 will ultimately correspond to the data of a specific output of the transformer 66.

The transformer 66 ensures fine-tuning of the transformations with regard to the relationship of the different output data measured against specific input data based on the structure and ultimately based on the output probabilities.

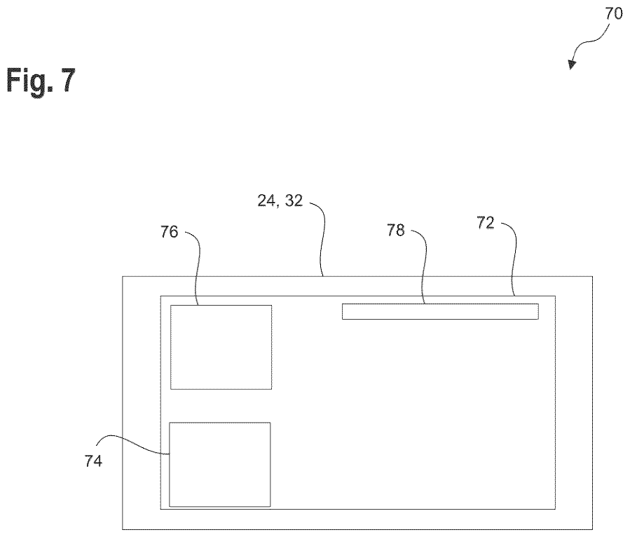

FIG. 7 shows a simplified schematic representation of an exemplary output 70 of the image data using an output device 24 in the context of the method 50.

The output 70 is carried out here as an example using a smartphone 32, which acts as an output device 24. The smartphone 32 has a screen 72. The evaluated image data are displayed on the screen 72. In addition, according to this example output 70, read-out diagnostic data 74 are displayed in an overlaid display window. Even if the diagnostic data 74 are displayed directly here, this is not mandatory. The diagnostic data 74 can also only be used in the context of the evaluation of the captured image data and cannot be displayed. Furthermore, according to this exemplary output 70, optional additional information 76 is displayed, such as which components are used in the context of the maintenance or repair measures. In addition, according to the exemplary embodiment the output 70 includes a progress bar to show progress information 78. The progress bar indicates the progress of the activities measured against a maintenance protocol. The additional information 76 and the progress information 78 are also optional for the output of the evaluated image data.

Specific embodiments disclosed herein use circuits (for example, one or more circuits) to implement standards, protocols, methods, or technologies disclosed here, to functionally couple two or more components, to generate information, to process information, to analyze information, to generate signals, to encode/decode signals, to convert signals, to transmit and/or receive signals, to control other devices, etc. Circuits of any kind can be used.

In one embodiment, a circuit such as the control device contains, among other things, one or more data processing devices such as a processor (for example, a microprocessor), a central processing unit (CPU), a digital signal processor (DSP), an application-specific integrated circuit (ASIC), a field-programmable gate array (FPGA), a system on a chip (SoC), or similar, or any combination thereof, and can contain discrete digital or analog circuit elements or electronics or combinations thereof. In one embodiment, the circuit contains hardware circuit implementations (for example, implementations in analog circuits, implementations in digital circuits, and the like, and combinations thereof).

In one embodiment, circuits contain combinations of circuits and computer program products with software or firmware instructions stored in one or more computer-readable memories and work together to cause a device to execute one or more of the protocols, methods, or technologies described herein. In one embodiment, the circuit technology includes circuits, such as microprocessors or parts of microprocessors, that require software, firmware, and the like to operate. In one embodiment, the circuits contain one or more processors or parts thereof and the associated software, firmware, hardware, and the like.

This disclosure can refer to quantities and numbers. Unless expressly stated, such quantities and numbers are not to be regarded as limiting, but as examples of the possible quantities or numbers in connection with the disclosure. In this context, the term “plural” can also be used in the disclosure to refer to a quantity or number. In this context, the term “plurality” refers to any number that is greater than one, for example two, three, four, five, etc. The terms “about”, “approximately”, “near”, etc. mean plus or minus 5% of the stated value.

Although the disclosure has been presented and described in relation to one or more embodiments, after reading and understanding this description and the accompanying drawings, the person skilled in the art will be able to make equivalent changes and modifications.

We claim:

1. A method for monitoring a vehicle, comprising the steps of:
capturing at least image data relating to a vehicle in a workshop inaccessible to the vehicle user by at least several cameras;
evaluating at least the captured image data by a control device based on at least one algorithm including generative artificial intelligence, wherein the algorithm selects, at least temporarily, those image data that correspond to a specific camera perspective of one of the multiple cameras, based on which maintenance or repair operation performed on the vehicle can be optimally recognized; and
outputting at least the evaluated image data by at least one output device.

2. The method of claim 1, wherein the control device additionally evaluates the captured image data with regard to a maintenance protocol to be carried out in respect of the vehicle, and when the image data are output additionally outputs progress information indicating the progress with respect to the maintenance protocol.

3. The method of claim 1, wherein the control device adapts the captured image data in such a way as to make the faces and/or personal information of persons unrecognizable.

4. The method of claim 1, wherein the control device additionally outputs at least one additional information item when outputting the image data.

5. The method of claim 1, wherein the captured image data are processed in a server data memory by the control device.

6. The method of claim 1, wherein the algorithm of the control device has at least one object-tracking algorithm.

7. The method of claim 1, wherein the diagnostic data are read out from the vehicle by means of at least one diagnostic device coupled to a data bus of the vehicle, and the read out diagnostic data are additionally taken into account in the evaluation of the captured image data by the control device.

8. The method of claim 1, wherein the algorithm of the control device has at least one large language model, wherein the data processed in the large language model are converted into token sequences and processed.

9. The method of claim 1, wherein audio data relating to the vehicle in the workshop inaccessible to the vehicle user are also captured by at least one microphone and are taken into account during the evaluation by the control device.

10. The method of claim 1, wherein the output device is wirelessly coupled to the control device.

11. The method of claim 1, wherein the method takes place in real time except for the time required for the acquisition and evaluation of the image data and the output of the evaluated image data.

12. A system for monitoring a vehicle, comprising:
two or more cameras;
a server data memory coupled to the cameras;
a control device coupled to the server data memory; and
at least one output device coupled to the control device,
wherein the cameras are located in a workshop inaccessible to the vehicle user and set up at least to collect image data relating to a vehicle in the workshop and to transmit the captured image data to the server data memory, wherein the control device is at least set up to evaluate at least the captured image data based on at least one algorithm comprising generative artificial intelligence and to output the evaluated image data by means of the at least one output device, wherein the algorithm selects, at least temporarily, those image data that correspond to a specific camera perspective of one of the several cameras, on the basis of which a maintenance or repair measure carried out on the vehicle can be optimally recognized.

13. The system of claim 12, wherein the control device additionally evaluates the captured image data with regard to a maintenance protocol to be carried out in respect of the vehicle, and when the image data are output additionally outputs progress information indicating the progress with respect to the maintenance protocol.

14. The system of claim 12, wherein the control device adapts the captured image data in such a way as to make the faces and/or personal information of persons unrecognizable.

15. The system of claim 12, wherein the control device additionally outputs at least one additional information item when outputting the image data.

16. The system of claim 12, wherein the captured image data are processed in a server data memory by the control device.

17. The system of claim 12, wherein the algorithm of the control device has at least one object-tracking algorithm.

18. The system of claim 12, wherein the diagnostic data are read out from the vehicle by means of at least one diagnostic device coupled to a data bus of the vehicle, and the read out diagnostic data are additionally taken into account in the evaluation of the captured image data by the control device.

19. The system of claim 12, wherein the algorithm of the control device has at least one large language model, wherein the data processed in the large language model are converted into token sequences and processed.

20. The system of claim 12, wherein audio data relating to the vehicle in the workshop inaccessible to the vehicle user are also captured by at least one microphone and are taken into account during the evaluation by the control device.
